(19) United States
(12) Patent Application Publication
(10) Pub. No.: US 2022/0256273 A1
(43) Pub. Date: Aug. 11, 2022

(54) SYSTEMS, HEADPHONES AND METHODS FOR INTERCHANGEABLE EAR CUP CUSHIONS ON HEADPHONES WITH RFID SENSING FOR AUTOMATED SOUND PERFORMANCE CONFIGURATION

(71) Applicant: HED Technologies Sarl, Geneva (CH)

(72) Inventors: John Timothy Degraye, Geneva (CH); Liliane Huguet, Geneva (CH)

(21) Appl. No.: 17/576,328

(22) Filed: Jan. 14, 2022

Related U.S. Application Data
(60) Provisional application No. 63/137,909, filed on Jan. 15, 2021.

(51) Int. Cl. H04R 1/10; G06K 7/10

(52) U.S. Cl. CPC H04R 1/1041; H04R 1/105; G06K 7/10237; H04R 1/1008; H04R 1/1066

(57) ABSTRACT

A headphone comprises a band; right and left ear cup bases coupled to the band, the right and left ear cup bases including right and left speakers; a radio-frequency identification (RFID) sensor; right and left ear cup cushions removably coupleable to the right and left ear cup bases using a mounting mechanism, at least one of the right and left ear cup cushions including an RFID tag, the RFID tag including configuration information; and a control system configured to obtain the configuration information from the RFID tag via the RFID sensor, to obtain configuration settings associated with the configuration information, and generate configuration parameters for driving the right and left speakers based on the configuration information and the configuration settings.

### CROSS REFERENCE TO RELATED APPLICATION

This application is a nonprovisional of and claims the benefit of U.S. Provisional Application Ser. No. 63/137,909, filed on Jan. 15, 2021, entitled “SYSTEMS, HEADPHONES AND METHODS FOR INTERCHANGEABLE EAR CUP CUSHIONS ON HEADPHONES WITH RFID SENSING FOR AUTOMATED SOUND PERFORMANCE CONFIGURATION” is incorporated by reference in its entirety herein for all purposes.

### TECHNICAL FIELD

This invention relates generally to headphones, and provides headphones with interchangeable ear cup cushions, and more particularly provides interchangeable ear cup cushions on headphones with embedded radio frequency identification (RFID) sensing to enable automated sound performance configuration based on the ear cup cushion configuration information.

### BACKGROUND

Headphones come in a wide range of shapes, sizes, types, and audio performance. Variations in headphone shape, size, type and/or audio performance may dictate the user, the manner in which the headphone is worn by a user, its comfort, the extent to which ambient noise is blocked by the headphone, the environments in which it is used, etc. Example headphone types include on-ear headphones and over-ear headphones, both including ear cup cushions designed to rest on or over the ears of a user. Some users may own multiple headphones for multiple different uses.

### SUMMARY

In some embodiments, the present invention provides a headphone, comprising a band; right and left ear cup bases coupled to the band, the right and left ear cup bases including right and left speakers; a radio-frequency identification (RFID) sensor; right and left ear cup cushions removably coupleable to the right and left ear cup bases using a mounting mechanism, at least one of the right and left ear cup cushions including an RFID tag, the RFID tag including configuration information; and a control system configured to obtain the configuration information from the RFID tag via the RFID sensor, to obtain configuration settings associated with the configuration information, and generate configuration parameters for driving the right and left speakers based on the configuration information and the configuration settings.

The mounting mechanism may include magnets, screws, clips and/or clamps. The configuration information may include one or more attributes about the right and left ear cup cushions. The configuration information may include an identifier that identifies one or more attributes about the right and left ear cup cushions. The configuration settings may be received from a separate computer device.

In some embodiments, the present invention provides a headphone portion, comprising a band; right and left ear cup bases coupled to the band, the right and left ear cup bases including right and left speakers; a radio-frequency identification (RFID) sensor; and a control system configured to obtain configuration information from an RFID tag in at least one ear cup cushion removably coupleable to the right ear cup base or the left ear cup base, to obtain configuration settings associated with the configuration information, and generate configuration parameters for driving the right and left speakers based on the configuration information and the configuration settings.

The mounting mechanism may include magnets, screw holes or bolts, clips or clamps, and/or protrusions to cooperate with clips or clamps. The configuration information may include one or more attributes about the right and left ear cup cushions. The configuration information may include an identifier that identifies one or more attributes about the right and left ear cup cushions. The configuration settings may be received from a separate computer device.

In some embodiments, the present invention provides an ear cup cushion for a headphone, comprising an ear cup cushion; a mounting mechanism for coupled to an ear cup base of a headphone; and an RFID tag including configuration information associated with the ear cup cushion.

The ear cup cushion may be an over-ear type and the configuration information may specify that the ear cup cushion is an over-ear type. The ear cup cushion may be an on-ear type and the configuration information may specify that the ear cup cushion is an on-ear type. The ear cup cushion may have a size and the configuration information may specify the size. The ear cup cushion may have a foam density and the configuration information may specify the foam density. The mounting mechanism ay include magnets, screw holes or bolts, clips or clamps, and/or protrusions.

### BRIEF DESCRIPTION OF THE DRAWINGS

FIG. 1 illustrates a perspective view of a headphone, in accordance with some embodiments.

FIG. 2 illustrates a front view of the headphone of FIG. 1, in accordance with some embodiments.

FIG. 3 illustrates a front view of the headphone of FIG. 1 with the ear cup cushions 1 removed, in accordance with some embodiments.

FIG. 4A illustrates a side view of a pair of interchangeable ear cup cushions detached from the headphone of FIG. 3, in accordance with some embodiments.

FIG. 4B illustrates a front view of an interchangeable ear cup cushion detached from the headphone of FIG. 3, in accordance with some embodiments.

FIG. 4C illustrates a front view of an interchangeable ear cup cushion detached from the headphone of FIG. 3, in accordance with some embodiments.

FIG. 4D illustrates a front view of an interchangeable ear cup cushion detached from the headphone of FIG. 3, in accordance with some embodiments.

FIG. 5 is a block diagram of the headphone of FIG. 1, in accordance with some embodiments.

FIG. 6 is a block diagram of a computer system with a configuration application for configuring the headphone of FIG. 5, in accordance with some embodiments.

FIG. 7 is a block diagram of the control system of FIG. 5, in accordance with some embodiments.

FIG. 8 is a block diagram illustrating details of a computer system, in accordance with some embodiments.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

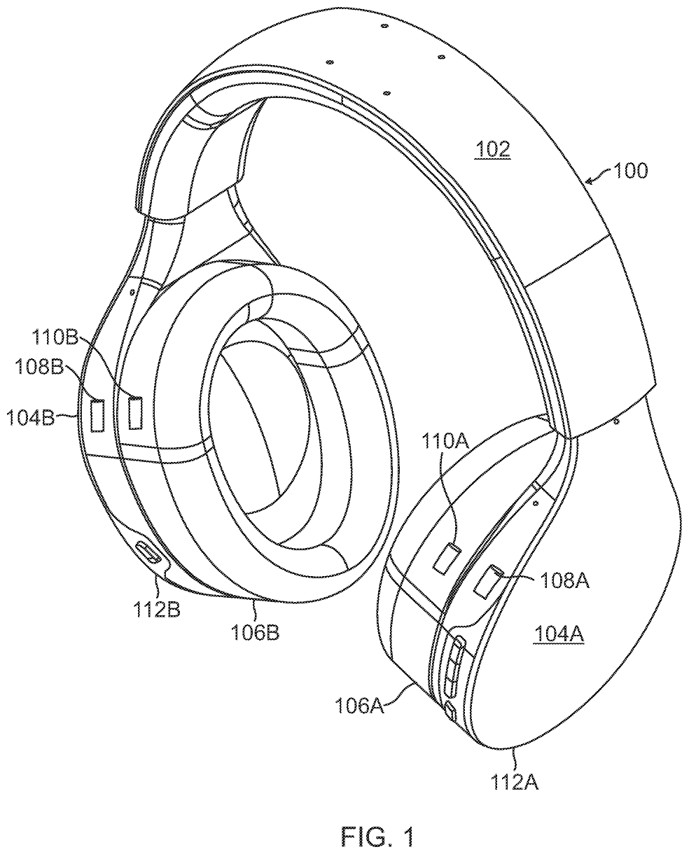

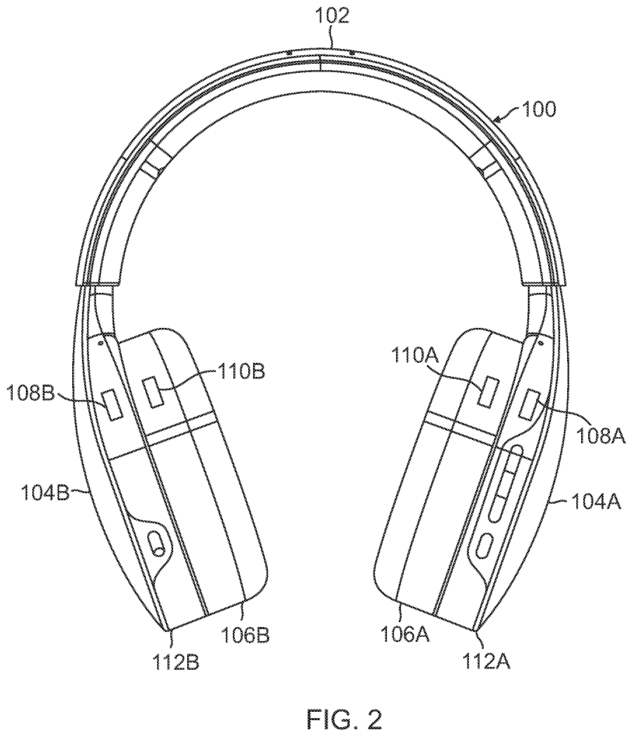

FIG. 1 is a perspective view of a headphone 100, in accordance with some embodiments. FIG. 2 illustrates a front view of the headphone 100, in accordance with some embodiments. The headphone 100 includes a band 102 coupled to right and left ear cup assemblies 104A and 104B, in accordance with some embodiments of the invention. The right and left ear cup assemblies 104A and 104B include right and left ear cup cushions 106A and 106B mounted to right and left ear cup bases 112A and 112B. The right and left ear cup bases 112A and 112B include right and left speakers. The headphone 100 may also include a microphone, a user interface (e.g., buttons, knobs, keypads, graphical user interface, etc.), a processor, memory, operating system, code, etc.

As indicated herein, the right and left ear cup cushions 106A and 106B may be removable and replaceable with different right and left ear cup cushions 106A and 106B having a different size, shape, softness, material, color, sound performance, etc.

In some embodiments, the band 102 is configured to extend over the head of the user and to support the right ear cup assembly 104A at one end and the left ear cup assembly 104B at the other end. The band 102 may be integrally formed with the right and left ear cup bases 112A and 112B or coupled to the right and left ear cup bases 112A and 112B via one or more mechanical couplings. The band 102 is typically flexible to allow for the headphone 100 to be resiliently placed on and removed from a user's head. In some embodiments, the band 102 includes a band cushion on an under side of the band 102 to add comfort when worn.

The band 102 may be designed to rest on the top of the wearer's head, around the back side of the neck, around the front side of the neck, or elsewhere when in use. In some embodiments, the headphone 100 may include no band 102, and instead may include connecting structures such as ear clips to retain the right and left ear cup assemblies 104A and 104B on or over the wearer's ears. In some embodiments, there may be only one ear cup assembly, e.g., a right ear cup assembly 104A or a left ear cup assembly 104B.

As indicated above, the right and left ear cup cushions 106A and 106B can be replaced for ones having different size, shape, design, type, color, material, foam density, sound performance, and/or the like. For instance, on-ear ear cup cushions 106A and 106B can be replaced with over-ear ear cup cushions 106A and 106B. The right and left ear cup cushions 106A and 106B can be replaced with ear cup cushions with a slit to support users who wear eyeglasses, as described in U.S. patent application Ser. No. 17/104,720, which is hereby incorporated by reference herein. The right and left ear cup cushions 106A and 106B can be replaced with right and left ear cup cushions 106A and 106B of a different color or pattern (for a different look), a different material, a different size, a different shape, a different foam, a different foam density, etc.

The right ear cup cushion 106A may be affixed to an inside surface of the right ear cup base 112A. Similarly, the left ear cup cushion 106B may be affixed to an inside surface of the right ear cup base 112B. Each of the right and left ear cup cushions 106A and 106B may have a back surface configured to flush mount to the inside wall of its respective right and left ear cup bases 112A and 112B. The right and left cushions 106A and 106B can be affixed to the right and left ear cup bases 112A and 112B using any coupling mechanism, including any one or combination of screws around the perimeter, hook-and-loop fasteners (such as Velcro™) on the back side, magnets along the perimeter or about the back side, clips or clamps along the perimeter, suction cups along the perimeter or about the back side, and/or the like.

In some embodiments, the right and left ear cup cushions 106A and 106B may include radio-frequency identification (RFID) tags 110A and 110B. The right and left ear cup bases 112A and 112B may include RFID sensors 108A and 108B. Each RFID tag 110A or 110B can identify to the headphone 100 configuration information about the associated ear cup cushion 106A or 106B. The configuration information may specify cushion attributes, e.g., the type (e.g., over-ear or on-ear), the particular foam density or a particular one of a set of particular foam densities (e.g., a stiff foam, medium foam or soft foam), the particular size or a particular one of a set of particular sizes (e.g., toddler size, teen size or adult size), the material (e.g., fabric, leather, PU leather, rubber), whether the each cup cushion 106A or 106B fully encapsulates the ear cup base 112A or 112B for waterproofing, etc. The configuration information may include an identifier that specifies the ear cushion attributes, which can be retrieved locally or remotely. In some embodiments, the headphone 100 may include only one RFID sensor/tag pair, e.g., on the right ear cup assembly 104A or on the left ear cup assembly 104B, since it is highly likely that ear cup configurations that match will be used on both sides. In some embodiments, the RFID sensor may be located in the band 102. In some embodiments, the headphone 100 may include a single RFID sensor capable of reading the configuration information from both the right and left RFID tags 110A and 110B.

The headphone 100 may use the configuration information from the RFID tags 110A and 110B and configuration settings associated therewith to generate configuration parameters for controlling the sound performance of the speakers. For example, users may prefer to lower base effects when ear cushions include stiffer foam. Parents may prefer a maximum volume level for teens that is lower than for adults and may prefer a maximum volume level even lower for toddlers. These configuration parameters to may be automatically set based on the size of the ear cup cushion.

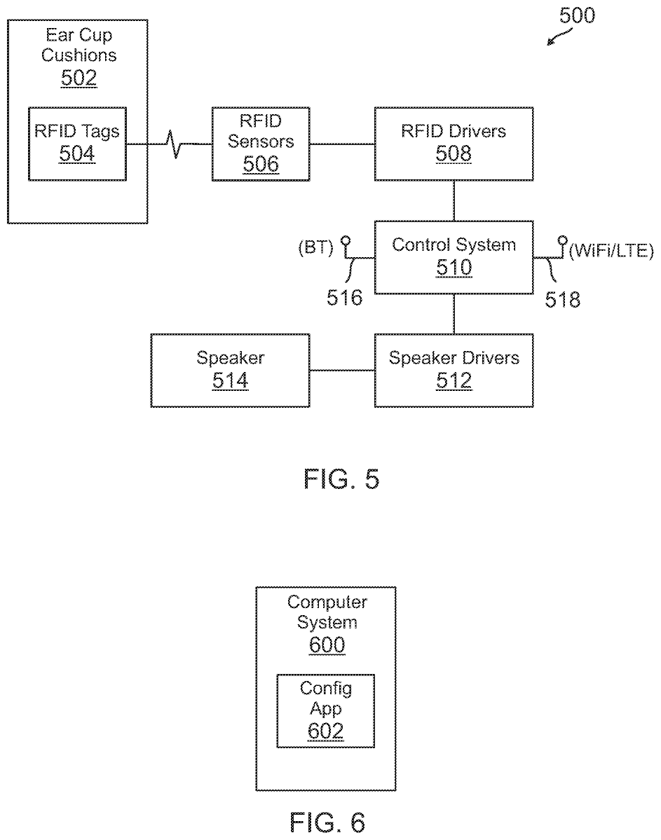

Because different ear cup cushions 106A and 106B may be used in different environments, e.g., on a plane, on the bed, in a spa, etc., the user may wish to set the configuration settings for each of several different pairs of ear cup cushions 106A and 106B. The configuration settings may have defaults that can be modified by the user, e.g., via an application on a computer device in communication with the headphone 100 (see configuration application 602 on computer system 600 in FIG. 6).

In some embodiments, the RFID tags 110A and 110B can also store authentication information to authenticate the ear cup cushions 106A and 106B as authentic and not knock-offs. In some embodiments, the headphone 100 may notify the user that the ear cup cushions 106A and 106B are knock-offs. In some embodiments, the headphone 100 may be designed to shut down or reduce functionality when the ear cup cushions 106A and 106B are knock-offs.

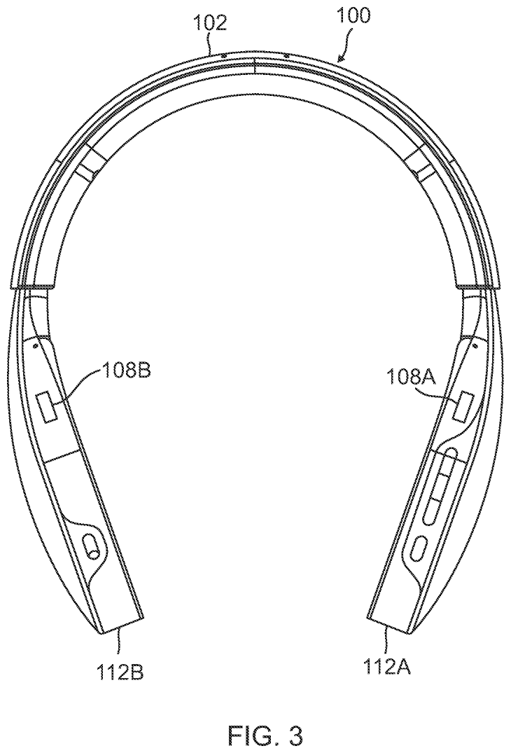

FIG. 3 illustrates a front view of headphone 100 with the right and left ear cup cushions 106A and 106B removed, in accordance with some embodiments. As shown, the headphone 100 includes the band 102, coupled to the right and left ear cup bases 112A and 112B, which include the right and left speakers. The right and left ear cup bases 112A and 112B include the right and left RFID sensors 108A and 108B. As noted above, in some embodiments, only one RFID sensor 108A or 108B may be needed, since it is highly likely that matching ear cup configurations will be used. The RFID sensor 108A or 108B may alternatively be located in the band 102.

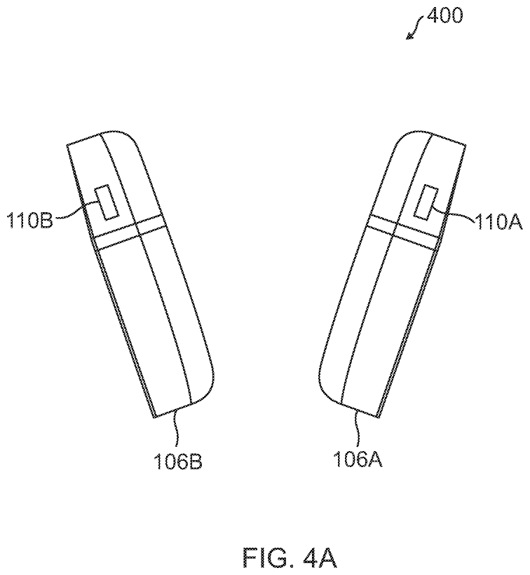

FIG. 4A illustrates a side view of right and left ear cup cushions 106A and 106B attachable to the headphone 100 (as shown in FIG. 3), in accordance with some embodiments. As shown, the right and left ear cup cushions 106A and 106B include right and left RFID tags 110A and 110B. As noted above, in some embodiments, only one RFID tag 110A or 110B may be needed, e.g., one in the right ear cup assembly 104A or one in the left ear cup assembly 104B, since it is highly likely that matching ear cup configurations will be used.

FIG. 4B illustrates a front view of an ear cup cushion 402 attachable to the headphone 100 (as shown in FIG. 3) using magnets or suction cups 404, in accordance with some embodiments. Although not shown, the ear cup base that receives the ear cup cushion 402 may include corresponding metal or magnets to cooperate with the magnets 404 of the ear cup cushion 402. Although not shown, the ear cup base that receives the ear cup cushion 402 may include a solid surface to cooperate with the suction cups 404 of the ear cup cushion 402.

FIG. 4C illustrates a front view of an ear cup cushion 406 attachable to the headphone 100 (as shown in FIG. 3) with screws 408, in accordance with some embodiments. Although not shown, the ear cup base and the ear cup cushion 406 may include screw holes or bolts to receive the screws 408. In some embodiments, the screws may go through holes in the ear cup base into the screw holes or bolts in the ear cup cushion 406. Alternatively, the screws may go through holes in the ear cup cushion 406 into the screw holes or bolts in the ear cup base.

FIG. 4D illustrates a front view of an ear cup cushion 410 attachable to the headphone 100 (as shown in FIG. 3) with clips or clamps 412, in accordance with some embodiments. Although not shown, the ear cup base that receives the ear cup cushion 410 may include protrusions to cooperate with the clips or clamps 412 of the ear cup cushion 410. In some embodiments, the clips or clamps may be on the base and the protrusions may be on the ear cup cushion 410.

Other coupling mechanisms and combinations of coupling mechanisms are also possible (e.g., magnets and screws, magnets and clips, magnets and clamps, etc.).

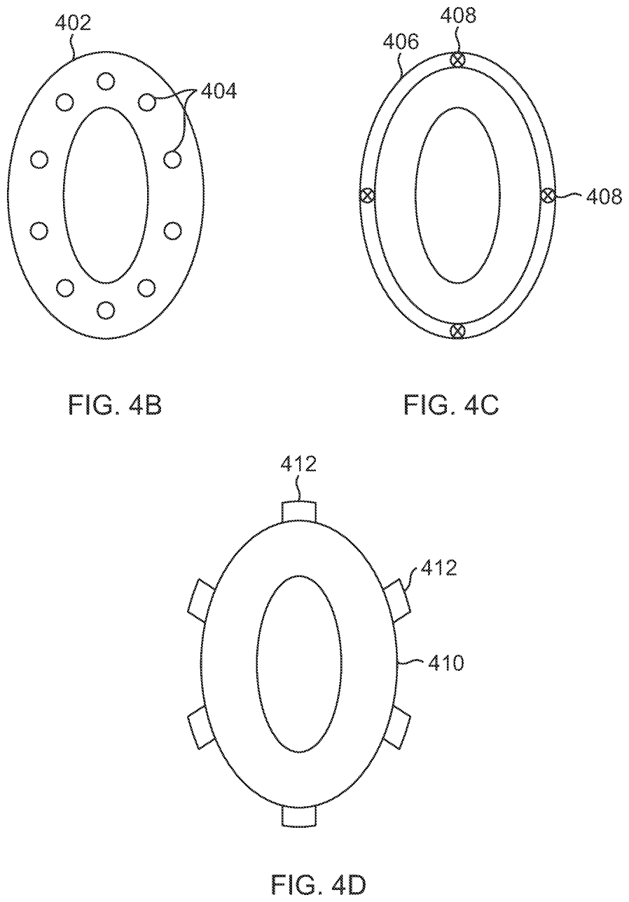

FIG. 5 is a block diagram of the headphone system 500, which may be an instance of the headphone 100, in accordance with some embodiments. The headphone system 500 includes ear cup cushions 502 (e.g., right and left ear cup cushions 106A and 106B) including RFID tags 504 (e.g., right and left RFID tags 110A and 110B), RFID sensors 504 (e.g., right and left RFID sensors 108A and 108B), coupled to RFID drivers 506, coupled to a control system 508, coupled to speaker drivers 512, coupled to speakers 514. The control system 510 may include or be coupled to a first antenna 516 (e.g., a Bluetooth antenna) for communicating with a computer system (e.g., an iPhone) for receiving configuration settings and/or audio for playback. Although shown herein as a wireless headphone 100, the headphone 100 may be connected via wire to the computer system. The control system 510 may include or be coupled to a second antenna 518 (e.g., a Wi-Fi antenna, second Bluetooth antenna, cellular (e.g., LTE) antenna, and/or the like) for communicating with other headphones 100 (as described in U.S. Pat. No. 10,390,122, which is hereby incorporated by reference herein) or with the Internet (e.g., for obtaining audio data for playback or general web navigation). The components and functions described in U.S. Pat. No. 10,390,122 are available as design choices and can be incorporated into the headphone 100 herein.

In operation, when the ear cup cushions 502 are mounted on the headphone 500 (e.g., on the right and left ear cup bases 112A and 112B), the RFID sensors 506 (as controlled by the RFID drivers 508) capture configuration information from the RFID tags 504. The configuration information is provided via the RFID drivers 506 to the control system 510. The control system 510 uses the configuration information to determine configuration parameters based on configuration settings (user and/or default settings). The control system 510 provides the configuration parameters to the speaker drivers 512, which drives the speakers 514 based on the configuration parameters.

In some embodiments, the RFID tags 504 can provide authentication information to the control system 510 to authenticate the ear cup cushions 502 as authentic and not knock-offs. In some embodiments, the control system 510 may be configured to notify the user when the ear cup cushions 502 are knock-offs. In some embodiments, the control system 510 may be designed to shut down or reduce functionality when the ear cup cushions 502 are knock-offs.

FIG. 6 is a block diagram of a computer system 600 with a configuration application 602 for configuring the headphone 100, in accordance with some embodiments. The computer system 600 may be a mobile device (e.g., a smart phone, a laptop, a car, a computer tablet, etc.) or a stationary device (e.g., a desktop, a cloud server, etc.). The configuration application 602 may include a graphical user interface to capture configuration settings (e.g., equalizer output settings, base level settings, treble level settings, mid-range level settings, maximum volume settings, etc.), which can be communicated with the headphone 500 (e.g., headphone 100), possibly via the first antenna 516 over Bluetooth. The configuration application 602 may associate the configuration settings with an identifier of the ear cup cushions 106A and 106B attached to the ear cup bases 112A and 112B. The configuration application 602 may store the configuration data, including the configuration information and the configuration settings. Alternatively, the configuration data may be stored only by the headphone 100.

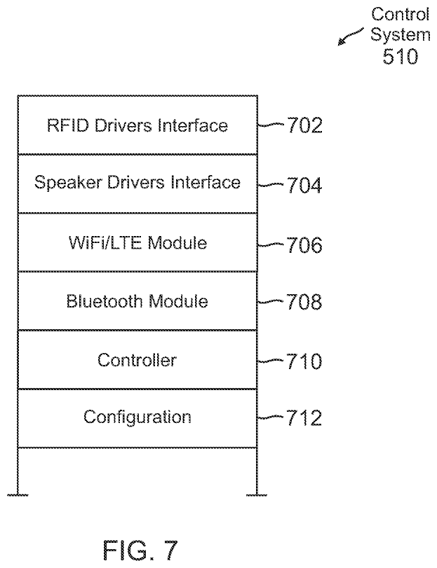

FIG. 7 is a block diagram of the control system 510, in accordance with some embodiments. The control system 510 includes an RFID driver interface 702, a speaker driver interface 704, a Wi-FI/LTE module 706, a Bluetooth module 708, a controller 710, and configuration data 712.

The RFID driver interface 702 includes hardware, software and/or firmware configured to communicate with the RFID drivers 508. The RFID driver interface 702 may receive the configuration information from the RFID tags 504 via the RFID sensors 506. The configuration information may be provided in the form of an ear cup cushion identifier, which may be used to obtain the ear cup cushion attributes from a local source or a remote source.

The speaker driver interface 704 includes hardware, software and/or firmware configured to communicate with the speaker drivers 512. The speaker driver interface 704 may receive the configuration parameters generated for controlling the speaker drivers 512 to drive the speakers accordingly.

The Wi-Fi/LTE module 706 includes hardware, software and/or firmware configured to communicate over the second antenna 518, e.g., with other headphones 100 or with the Internet, possibly to capture audio data (music, chat, web navigation data, etc.).

The Bluetooth module 708 includes hardware, software and/or firmware configured to communicate over the first antenna 516 with the computer system 600, e.g., for obtaining configuration settings and/or audio data.

The controller 710 includes hardware, software and/or firmware configured to manage the sound performance configuration of the headphone 500 based on the configuration information obtained from the RFID tags 504, based on the configuration settings obtained from the configuration application 602 or locally, and based on algorithms for generating configuration parameters based the configuration information and the configuration settings. The controller 710 may store the configuration data 712 in a configuration store. The configuration data 712 stored by the control system 510 may include the configuration information, the configuration settings associated with the configuration information, and the configuration parameters associated with the configuration information and configuration settings. In some embodiments, the configuration settings may be obtained by the controller 510 via a local user interface, e.g., a voice user interface (VUI), a graphical user interface (GUI), physical buttons or keys (e.g., a keypad) located on the headphone 500.

In some embodiments, the controller 710 may capture authentication information from the RFID tags 504 to authenticate the ear cup cushions 502 as authentic and not knock-offs. In some embodiments, the controller 710 may be configured to notify the user when the ear cup cushions 502 are knock-offs, e.g., via the headphone 500 or via the computer system 600. In some embodiments, the controller 710 may be designed to shut down or reduce functionality when the ear cup cushions 502 are knock-offs.

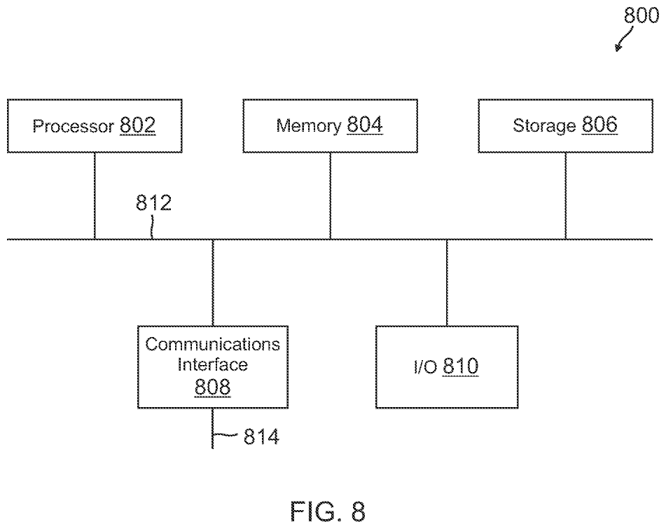

FIG. 8 is a block diagram illustrating details of a computer system 800. Any headphone, system, engine, database, module, and/or network described herein may comprise an instance of one or more computer systems 800. In some embodiments, one or more computer systems 800 perform some or all of the functionality described herein. The computer system 800 comprises a processor 802, memory 1104, storage 806, a communications interface 808, and an input/output (I/O) interface 810, each communicatively coupled to a communication channel 814. The processor 802 is configured to execute executable instructions (e.g., programs). In some embodiments, the processor 802 comprises circuitry or any processor capable of processing the executable instructions.

The memory 804 stores data. Some examples of memory 804 include RAM, ROM, RAM cache, virtual memory, hard drives, solid state memory, etc. In various embodiments, working data is stored within the memory 804. The data within the memory 804 may be cleared or ultimately transferred to the storage 806.

The storage 806 includes any storage configured to retrieve and store data. Some examples of the storage include flash drives, hard drives, optical drives, cloud storage, and/or magnetic tape. Each of the memory 804 and the storage 806 comprises a computer-readable medium, which stores instructions or programs executable by the processor 802.

The I/O interface 810 may include any device that inputs data (e.g., mouse and keyboard) and any device that outputs data (e.g., a speaker or display).

The communication interface 808 may support communication over an Ethernet connection, a serial connection, a parallel connection, and/or an ATA connection. The communications interface 808 may also support wireless communication (e.g., 802.11, Wi-Max, LTE, Wi-Fi). It will be apparent that the communication network interface 1108 may support many wired and wireless standards. The communications interface 808 may be coupled to a network (e.g., the Internet) via the link 812.

The elements of the computer system 800 are not limited to those depicted. A computer system 800 may comprise more or less hardware, software and/or firmware components than those depicted (e.g., drivers, operating systems, touch screens, biometric analyzers, and/or the like). Further, elements may share functionality and still be within various embodiments described herein. For example, encoding and/or decoding may be performed by the processor 802 and/or a co-processor located on a GPU (i.e., Nvidia).

It will be appreciated that the terms “engine”, “system” “module” and/or “database” may comprise software, hardware, firmware, and/or circuitry. In one example, one or more software programs comprising instructions capable of being executable by a processor may perform one or more of the functions of the engines, databases, modules or systems described herein. In another example, circuitry may perform the same or similar functions. Alternative embodiments may comprise more, less, or functionally equivalent engines, systems, modules or databases, and still be within the scope or present embodiments. For example, the functionality of the various systems, engines, modules and/or databases may be combined or divided differently. The databases may include cloud storage. It will further be appreciated that the term “or” as used herein may be construed in either an inclusive or exclusive sense. Moreover, plural instances may be provided for resources, operations, or structures described herein as a single instance.

Any database described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, modules, and/or databases described herein may be at least partially processor-implemented, with a particular processor or processors being an example of hardware. For example, at least some of the operations herein may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order described and/or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A headphone comprising:
a band;
right and left ear cup bases coupled to the band, the right and left ear cup bases including right and left speakers;
a radio-frequency identification (RFID) sensor;
right and left ear cup cushions removably coupleable to the right and left ear cup bases using a mounting mechanism, at least one of the right and left ear cup cushions including an RFID tag, the RFID tag including configuration information; and
a control system configured to obtain the configuration information from the RFID tag via the RFID sensor, to obtain configuration settings associated with the configuration information, and generate configuration parameters for driving the right and left speakers based on the configuration information and the configuration settings.

2. The headphone of claim 1, wherein the mounting mechanism includes magnets.

3. The headphone of claim 1, wherein the mounting mechanism includes screws.

4. The headphone of claim 1, wherein the mounting mechanism includes clips or clamps.

5. The headphone of claim 1, wherein the configuration information includes one or more attributes about the right and left ear cup cushions.

6. The headphone of claim 1, wherein the configuration information includes an identifier that identifies one or more attributes about the right and left ear cup cushions.

7. The headphone of claim 1, wherein the configuration settings are received from a separate computer device.

8. A headphone portion, comprising:
a band;
right and left ear cup bases coupled to the band, the right and left ear cup bases including right and left speakers;
a radio-frequency identification (RFID) sensor; and
a control system configured to obtain configuration information from an RFID tag in at least one ear cup cushion removably coupleable to the right ear cup base or the left ear cup base, to obtain configuration settings associated with the configuration information, and generate configuration parameters for driving the right and left speakers based on the configuration information and the configuration settings.

9. The headphone portion of claim 8, wherein the mounting mechanism includes magnets.

10. The headphone portion of claim 8, wherein the mounting mechanism includes screw holes or bolts.

11. The headphone portion of claim 8, wherein the mounting mechanism includes clips or clamps.

12. The headphone portion of claim 8, wherein the mounting mechanism includes protrusions to cooperate with clips or clamps.

13. The headphone portion of claim 8, wherein the configuration information includes one or more attributes about the right and left ear cup cushions.

14. The headphone portion of claim 8, wherein the configuration information includes an identifier that identifies one or more attributes about the right and left ear cup cushions.

15. The headphone portion of claim 8, wherein the configuration settings are received from a separate computer device.

16. An ear cup cushion for a headphone, comprising:
an ear cup cushion;
a mounting mechanism for coupled to an ear cup base of a headphone; and
an RFID tag including configuration information associated with the ear cup cushion.

17. The ear cup cushion of claim 16, wherein the ear cup cushion is an over-ear type and the configuration information specifies that the ear cup cushion is an over-ear type.

18. The ear cup cushion of claim 16, wherein the ear cup cushion is an on-ear type and the configuration information specifies that the ear cup cushion is an on-ear type.

19. The ear cup cushion of claim 16, wherein the ear cup cushion has a size and the configuration information specifies the size.

20. The ear cup cushion of claim 16, wherein the ear cup cushion has a foam density and the configuration information specifies the foam density.

21. The ear cup cushion of claim 16, wherein the mounting mechanism includes magnets.

22. The ear cup cushion of claim 16, wherein the mounting mechanism includes screw holes or bolts.

23. The ear cup cushion of claim 16, wherein the mounting mechanism includes clips or clamps.

24. The ear cup cushion of claim 16, wherein the mounting mechanism includes protrusions.
